(19) United States
(12) Patent Application Publication
(10) Pub. No.: US 2021/0185304 A1
(43) Pub. Date: Jun. 17, 2021

(54) DISPLAY DEVICE AND OPERATING METHOD OF THE SAME

(71) Applicant: SAMSUNG ELECTRONICS CO., LTD., Suwon-si (KR)

(72) Inventors: Minsang KIM, Suwon-si (KR); Jongjin PARK, Suwon-si (KR); Hyunjong SHIN, Suwon-si (KR); Seokhyun YOON, Suwon-si (KR)

(73) Assignee: SAMSUNG ELECTRONICS CO., LTD., Suwon-si (KR)

(21) Appl. No.: 17/119,444

(22) Filed: Dec. 11, 2020

(30) Foreign Application Priority Data
Dec. 13, 2019 (KR) 10-2019-0167135

(51) Int. Cl. H04N 17/04; H04N 21/4363; H04N 21/4425; H04N 7/01

(52) U.S. Cl. CPC H04N 17/045; H04N 7/0117; H04N 21/4425; H04N 21/43635

(57) ABSTRACT

Provided are a display device and an operation method of controlling the same. The operating method of the display device configured to receive contents through a high-definition multimedia interface (HDMI) communication from an image providing apparatus includes performing HDMI communication with the image providing apparatus, detecting an error of an HDMI communication channel, calculating an error value of the HDMI communication channel by using a predefined channel performance measurement algorithm based on the error of the HDMI communication channel being detected, determining whether to change extended display identification data (EDID) based on the calculated error value, and outputting the contents based on the EDID corresponding to a result of the determining.

### CROSS-REFERENCE TO RELATED APPLICATION

This application is based on and claims priority under 35 U.S.C. § 119 to Korean Patent Application No. 10-2019-0167135, filed on Dec. 13, 2019, in the Korean Intellectual Property Office, the disclosure of which is incorporated by reference herein in its entirety.

### BACKGROUND

### 1. Field

The disclosure relates to a display device and an operating method thereof, and more particularly, to a display device for adaptively outputting contents based on detection of performance of a high definition multimedia interface (HDMI) communication channel, and an operating method of the display device.

### 2. Description of Related Art

A high definition multimedia interface (HDMI) is one of digital video/audio interface standards. The HDMI provides an interface between a source device such as a set-top box, a digital versatile disk (DVD) player, etc., supporting an HDMI, and a sink device such as an audio/video (AN) device, a monitor, a digital television (TV), etc.

As the consumer demand for high resolution and high definition increases together with the diversification of digital facilities, a research on a method of providing an adaptively optimized display has been actively conducted to improve the quality of HDMI cable to match image qualities between a sink device and a source device, etc.

### SUMMARY

Provided are a display device for adaptively outputting contents based on detection of performance of a high-definition multimedia interface (HDMI) communication channel, and an operating method of the display device.

Technical problems to be solved in the disclosure are not limited to the above-mentioned technical problems, and other technical problems may be understood by those of skill in the art from the following descriptions.

Additional aspects will be set forth in part in the description which follows and, in part, will be apparent from the description, or may be learned by practice of the presented embodiments.

According to an embodiment, there is provided an operating method of a display device configured to receive contents through a high-definition multimedia interface (HDMI) communication from an image providing apparatus. The operating method includes: performing the HDMI communication with the image providing apparatus; detecting an error of an HDMI communication channel; calculating an error value of the HDMI communication channel by using a predefined channel performance measurement algorithm based on the error of the HDMI communication channel being detected; determining whether to change extended display identification data (EDID) based on the calculated error value; and outputting the contents based on the EDID corresponding to a result of the determining.

The determining of whether to change the EDID includes: comparing the calculated error value with a preset threshold value; and changing the EDID based on determining that the error value is greater than or equal to the preset threshold value, and wherein the outputting of the contents comprises outputting the contents based on the changed EDID.

The changing of the EDID includes changing a screen resolution based on the changed EDID.

The changing of the EDID includes outputting an interface for notifying a user about the error of the HDMI communication channel.

The determining of whether to change the EDID includes: comparing the calculated error value with a preset threshold value; and maintaining the EDID based on the error value being less than the preset threshold value, and wherein the outputting of the contents comprises outputting the contents based on the EDID.

The predefined channel performance measurement algorithm includes an algorithm that calculates the error value while changing an EQ value.

According to an embodiment, there is provided a display device configured to receive contents through a high-definition multimedia interface (HDMI) communication from an image providing apparatus. The display device includes: a communicator; a memory storing one or more instructions; and a processor configured to execute the one or more instructions stored in the memory to: perform the HDMI communication with the image providing apparatus through the communicator; detect an error of an HDMI communication channel; calculate an error value of the HDMI communication channel by using a predefined channel performance measurement algorithm based on the error of the HDMI communication channel being detected; determine whether to change extended display identification data (EDID) based on the calculated error value; and output the contents based on the EDID corresponding to a result of the determining.

The processor is further configured to: compare the calculated error value with a preset threshold value; change the EDID when the error value is greater than or equal to the preset threshold value; and output the contents based on the changed EDID.

The processor is further configured to change a screen resolution based on the changed EDID.

The processor is further configured to output an interface for notifying a user about the error of the HDMI communication channel.

The processor is further configured to: compare the calculated error value with a preset threshold value; maintain the EDID based on the error value being less than the preset threshold value; and output the contents based on the EDID.

The predefined channel performance measurement algorithm includes an algorithm that calculates the error value while changing an EQ value.

According to an embodiment, there is provided a non-transitory computer-readable recording medium having recorded thereon a program for executing the method described above on a computer.

### BRIEF DESCRIPTION OF THE DRAWINGS

The above and other aspects, features, and advantages of certain embodiments of the disclosure will become more apparent from the following description taken in conjunction with the accompanying drawings, in which:

FIG. 1 is a diagram illustrating a system for providing video contents, according to an embodiment;

FIG. 2 is a diagram illustrating a high-definition multimedia interface (HDMI) system according to an embodiment;

FIG. 3 is a flowchart of an operating method of a display device according to an embodiment;

FIG. 4 is a flowchart for describing a method, performed by a display device, of changing or maintaining extended display identification data (EDID) based on an error of an HDMI communication channel, according to an embodiment;

FIG. 5 is a flowchart for describing an example in which a display device changes EDID, according to an embodiment;

FIG. 6 is a view illustrating an example of an interface output by a display device, according to an embodiment;

FIG. 7 is a flowchart of an operating method of a display device and an image providing apparatus, according to an embodiment;

FIG. 8 is a block diagram of a display device according to an embodiment; and

FIG. 9 is a detailed block diagram of a display device according to an embodiment.

### DETAILED DESCRIPTION

Hereinafter, embodiments of the disclosure will be described in detail with reference to the accompanying drawings to allow those of ordinary skill in the art to easily understand and practice the embodiments of the disclosure. However, the embodiments may be implemented in various forms, and are not limited to the embodiments of the disclosure described herein. To clearly describe the disclosure, parts that are not associated with the description have been omitted, and throughout the disclosure, identical reference numerals refer to identical parts.

Although terms used in the disclosure are selected with general terms popularly used at present under the consideration of functions in the disclosure, the terms may vary according to the intention of those of ordinary skill in the art, judicial precedents, or introduction of new technology. Thus, the terms used in the disclosure should be defined not by the simple names of the terms but in the context of the description in the disclosure.

Terms such as first, second, and the like may be used to describe various elements, but the elements should not be limited to those terms. These terms may be used for the purpose of distinguishing one element from another element.

Throughout the disclosure, the expression “at least one of a, b or c” indicates only a, only b, only c, both a and b, both a and c, both b and c, all of a, b, and c, or variations thereof.

The terms used in the disclosure are for the purpose of describing particular exemplary embodiments only and are not intended to limit the scope of the disclosure. The singular forms are intended to include the plural forms as well, unless the context clearly indicates otherwise. Throughput the disclosure, when a part is connected to another part, the part is not only directly connected to another part but also electrically connected to another part with another device intervening in them. When it is assumed that a certain part includes a certain component, the term “including” means that a corresponding component may further include other components unless a specific meaning opposed to the corresponding component is written.

In the present disclosure, especially, in the claims, the use of “the” and other demonstratives similar thereto may correspond to both a singular form and a plural form. Unless the order of operations of a method according to the disclosure is explicitly mentioned or described otherwise, the operations may be performed in a proper order. The disclosure is not limited by the order the operations are mentioned.

The phrase used in various parts of the present disclosure, such as “in some embodiments” or “in an embodiment” does not necessarily indicate the same embodiment.

Some embodiments of the disclosure may be represented by block components and various process operations. All or some of such functional blocks may be implemented by various hardware and/or software components or a combination thereof. For example, functional blocks of the disclosure may be implemented with one or more microprocessors or circuit elements for a specific function. The functional blocks of the disclosure may also be implemented with various programming or scripting languages. The functional blocks may be implemented as an algorithm executed in one or more processors. Furthermore, the disclosure may employ any number of conventional techniques for electronics configuration, signal processing and/or control, data processing and the like. The term “mechanism”, “element”, “means”, or “component” is used broadly and is not limited to mechanical or physical embodiments.

Connecting lines or connecting members between elements shown in the drawings are to illustrate functional connections and/or physical or circuit connections. In an actual device, connections between elements may be indicated by replaceable or added various functional connections, physical connections, or circuit connections.

Hereinafter, the disclosure will be described with reference to the accompanying drawings.

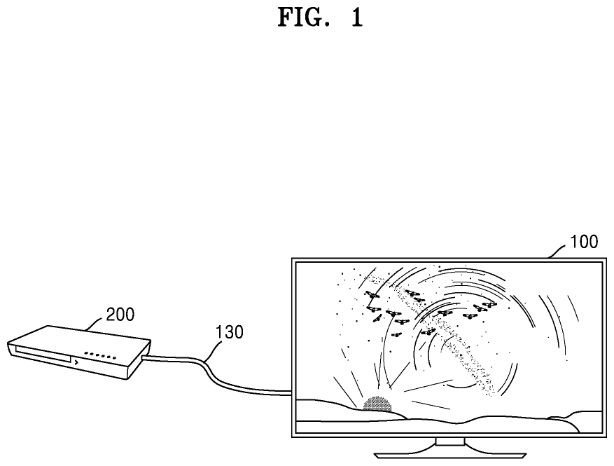

FIG. 1 is a diagram illustrating a system for providing video contents according to an embodiment.

Referring to FIG. 1, a system for providing video contents according to an embodiment may include a display device 100 and an image providing apparatus 200. The display device 100 may be connected to the image providing apparatus 200 through a high-definition multimedia interface (HDMI) cable 130.

The image providing apparatus 200 according to an embodiment may mean an apparatus for providing video contents. For example, the image providing apparatus 200 may include a set-top box, a Blue ray disk player, a digital versatile disk (DVD) player, a game console, a digital camera, a camcorder, a computer (laptop computer), an audio/video (AV) receiver, a cellular phone, etc. The image providing apparatus 200 may be a cable receiving apparatus or a satellite broadcasting receiving apparatus that receives contents through electromagnetic waves or a cable. The image providing apparatus 200 may be an Internet receiving apparatus that receives contents from an over-the-top (OTT) service provider that provides contents over an Internet network. However, the embodiment is not limited thereto, and the image providing apparatus 200 may be implemented in various forms.

The display device 100 according to an embodiment may be a device capable of displaying image contents provided from the image providing apparatus 200. The display device 100 according to an embodiment may be a TV, but this is merely an example and may also be implemented with an electronic device including a display. For example, the display device 100 may be implemented with various electronic devices such as a cellular phone, a tablet personal computer (PC), a digital camera, a camcorder, a laptop computer, a desktop, an electronic(e)-book terminal, a digital broadcasting terminal, a personal digital assistant (PDA), a portable multimedia player (PMP), a navigator, an MP3 player, a wearable device, and so forth. In particular, embodiments of the disclosure may be easily implemented in, but not limited to, a display device including a large-size display such as a TV. The display device 100 may be of a fixed type or a mobile type, and may be a digital broadcasting receiver capable of receiving digital broadcasting.

The display device 100 may be implemented with not only a flat display device, but also a curved display device provided with a screen having a curvature or a flexible display device having an adjustable curvature. An output resolution of the display device 100 may include, for example, high definition (HD), full HD, ultra HD, or a higher resolution than ultra HD.

According to an embodiment, the display device 100 may receive contents such as an audio signal, a video signal, etc., from the image providing apparatus 200 and output the received contents.

According to an embodiment, the display device 100 may be connected with the image providing apparatus 200 through the HDMI cable 130 to transmit or receive video information, audio information, etc.

The HDMI is an interface capable of simultaneously transmitting a digital audio signal and a digital video signal through one cable. The HDMI cable 130 may be a non-compression digital cable that transmits contents to the display device 100 without compressing the contents. A connector may be provided at both ends of the HDMI cable 130 and may be connected to a port provided in each of the display device 100 and the image providing apparatus 200 to enable signal transmission using the HDMI cable 130 between the display device 100 and the image providing apparatus 200.

According to an embodiment, the display device 100 may display contents received from the image providing apparatus 200 through the HDMI cable 130.

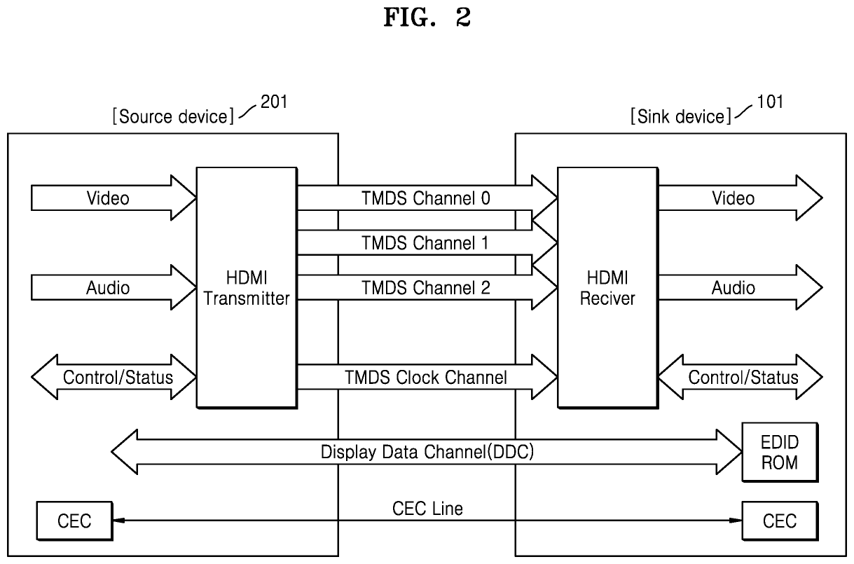

FIG. 2 illustrates an HDMI system according to an embodiment.

Referring to FIG. 2, the HDMI system may include a sink device 101 and a source device 201.

According to an embodiment, the sink device 101 shown in FIG. 2 may be the display device 100 shown in FIG. 1. The source device 201 shown in FIG. 2 may be the image providing apparatus 200 shown in FIG. 1.

The sink device 101 may be a device capable of receiving and outputting contents from the source device 201 such as a monitor, a digital TV, etc. The source device 201 like the set-top box may transmit image contents to the sink device 101. The sink device 101 and the source device 201 may be connected through channels complying with the HDMI standard and transmit and receive a digital signal.

The HDMI interface may include a plurality of independent communication channel/lines such as transition minimized differential signaling (TMDS), a display data channel (DDC), consumer electronics control (CEC), etc. The sink device 101 and the source device 201 may transmit and receive an audio signal and/or a video signal, device information, a control command, etc.

The source device 201 and the sink device 101 may transmit and receive a control command through a CEC channel. The CEC channel, which is a protocol executing a high-level control function in the HDMI, may regulate interaction between the sink device 101 and the source device 201. The sink device 101 and the source device 201 may perform auto power-on, auto signal routing, remote control, etc., through a CEC line.

The TMDS channel is a channel in charge of transmission and reception of a video signal and an audio signal. The source device 201 may transmit a video signal and an audio signal included in image contents to the sink device 101 through a TMDS channel. The sink device 101 may receive a video signal and an audio signal through the TMDS channel.

The sink device 101 may store standard information of the sink device 101 in extended display identification data (EDID) read-only memory (ROM).

The source device 201 may extract details information stored in an HDMI ROM of the sink device 101 and transmit optimized video signal and audio signal to the sink device 101 through the DDC channel. The DDC channel, which is a data communication standard defined in the international standard organization, the Video Electronics Standards Association (VESA), may have a function capable of implementing an optimal screen by referring to the standard information of the sink device 101.

The source device 201 may recognize details information of the sink device 101 through EDID output by the sink device 101 through the DDC channel. The source device 201 may convert data to be compatible with a display environment of the sink device 101 by using the details information of the sink device 101 and output the converted data to the sink device 101 through the TMDS channel.

The EDID, which is a standard for transmitting display information from a display device (sink device) to a source device, may define a data format for transmitting capabilities of the display to the source device. The EDID may include, for example, a product ID, a manufacturer ID, version information, a display support function, timing information, etc.

According to an embodiment, the source device 201 may transmit contents corresponding to a display environment of the sink device 101 by receiving the EDID from the sink device 101 through a DDC channel. Thus, the sink device 101 may output contents according its display environment.

Upon occurrence of an error in the HDMI communication channel, such as a connection state of the HDMI cable 130 being unstable, the display device 100 may not be able to continuously provide contents.

In this case, for example, the display device 100 may display a meaningless black screen or an abnormal screen, such a flickering screen, no signal, etc., and thereby, causing inconvenience to a user watching the contents.

According to an embodiment, upon occurrence of an error, the display device 100 may detect performance of the HDMI communication channel, change EDID and continuously display contents based on the changed EDID.

For example, to continuously display contents in a situation where a low-resolution screen is provided due to a problem in performance of the HDMI communication channel, the display device 100 may change a supportable resolution included in the EDID into a low resolution.

The display device 100 may transmit the changed EDID to the image providing apparatus 200 through the DDC channel. The image providing apparatus 200 may transmit contents appropriate for a changed display environment of the display device 100 by receiving the EDID through the DDC channel from the display device 100.

According to an embodiment, by receiving the contents based on the changed EDID from the image providing apparatus 200 and displaying the received contents, the display device 100 may minimize inconvenience of the user watching the contents based on continuous providing of the contents.

For example, the display device 100 may continuously output contents by receiving and displaying contents converted into low-resolution contents.

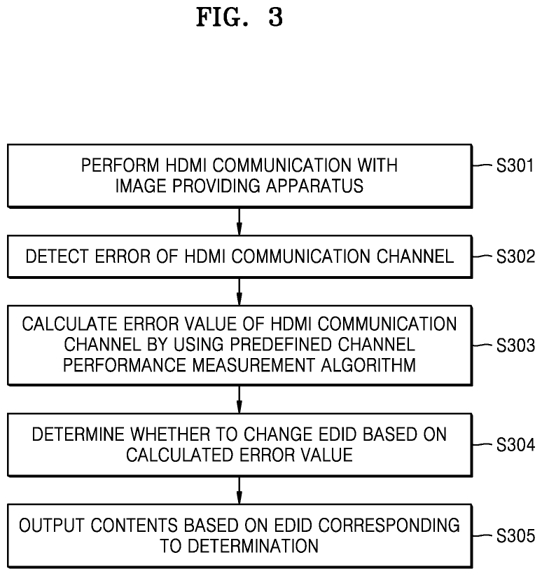

FIG. 3 is a flowchart of an operating method of a display device according to an embodiment.

Referring to FIG. 3, in operation S301, the display device 100 may perform HDMI communication with the image providing apparatus 200.

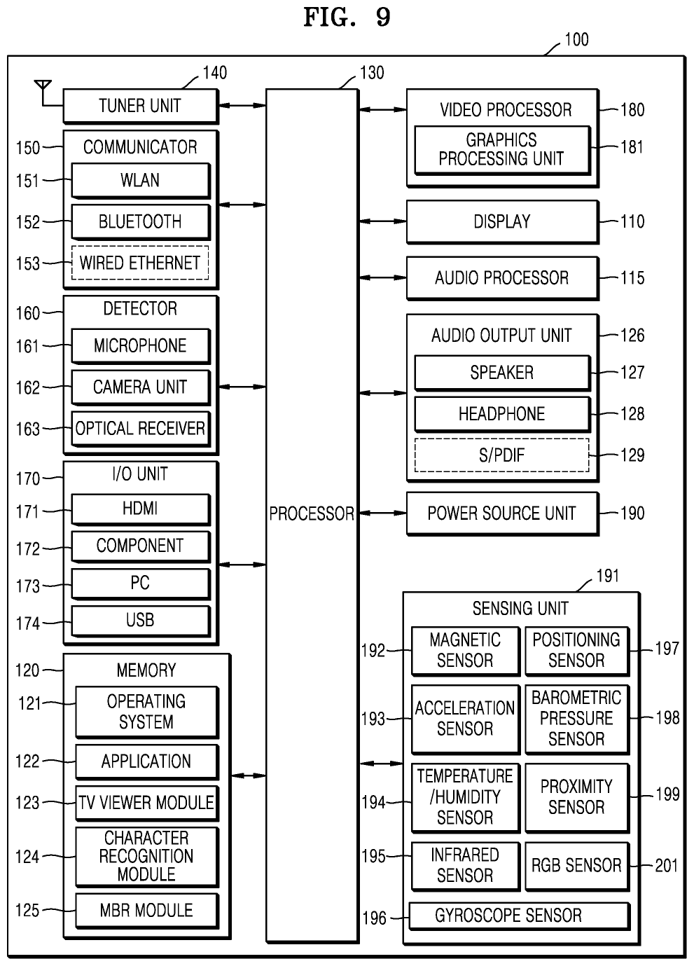

For example, the display device 100 may perform HDMI communication upon establishing a connection with the image providing apparatus 200 through an HDMI port 171 (shown in FIG. 9).

In operation S302, the display device 100 may detect an error of an HDMI communication channel.

According to an embodiment, the display device 100 may receive video information, audio information, etc., from the image providing apparatus 200 through the HDMI communication. The display device 100 may detect an error of a TMDS communication channel while receiving a video signal and an audio signal from the image providing apparatus 200 through the TMDS channel.

For example, the error of the HDMI communication channel may include, but not limited to, a case where a transmission device and a reception device (a source device and a sink device) are not compatible with each other, a case where an HDMI version does not match (e.g., the transmission device and the reception device are of HDMI 2.0 version, but the HDMI cable is of HDMI 1.4 version), a case where an HDMI cable has a long length (e.g., a long cable of 10 m or longer), a physical damage to the HDMI cable, etc. For example, as the resolution of video data supported by the transmission device and the reception device increases, the transmitted and the received high-resolution video data may not be able to support the HDMI cable.

According to an embodiment, the display device 100 may perform character error detection (CED) monitoring with respect to each TMDS channel through which a video signal and an audio signal are received. The display device 100 may monitor a data error by performing CED monitoring on the received data.

In operation S303, the display device 100 may calculate the error of the HDMI communication channel, by using a predefined channel performance measurement algorithm.

For example, the predefined channel performance measurement algorithm may be an algorithm that calculates the error value of the HDMI communication channel while changing an EQ value.

According to an embodiment, the display device 100 may calculate an error value of a TMDS channel while changing the EQ value. The EQ value in a changeable range may be stored in advance in the form of a table in a memory.

In operation S304, the display device 100 may determine based on the calculated error value whether the EDID is changed.

According to an embodiment, the display device 100 may determine whether the calculated error value of the TMDS channel is greater than or equal to a preset threshold value.

According to an embodiment, when the display device 100 determines that the calculated error value of the TMDS channel is greater than or equal to the preset threshold value, the display device 100 may change the EDID.

When the display device 100 determines channel performance degradation such that the error value of the TMDS channel is greater than or equal to a preset threshold value, while monitoring TMDS channel performance, the display device 100 may change the EDID to display a contents play screen with current TMDS channel performance.

According to an embodiment, when the display device 100 determines that the error value of the TMDS channel is less than the preset threshold value, the display device 100 may maintain the EDID without changing the EDID.

When the display device 100 determines that the error value of the TMDS channel is less than the preset threshold value, while monitoring TMDS channel performance, the display device 100 may display the contents play screen without changing the EDID.

In operation S305, the display device 100 may output the contents based on the EDID corresponding to a result of the determination.

According to an embodiment, when the display device 100 changes the EDI D, the display device 100 may output the contents based on the changed EDI D.

According to an embodiment, through the DDC channel, the display device 100 may transmit the changed EDID to the image providing apparatus 200 and receive the contents based on the changed EDID from the image providing apparatus 200.

Thus, the display apparatus 100 may receive and display the contents that may be adaptively displayed on the display device 100 according to HDMI channel performance, thereby minimizing inconvenience of a user watching the contents.

According to an embodiment, the display device 100 may display the contents received from the image providing apparatus 200 based on preset EDID when the display device 100 maintains the EDID without changing the EDI D.

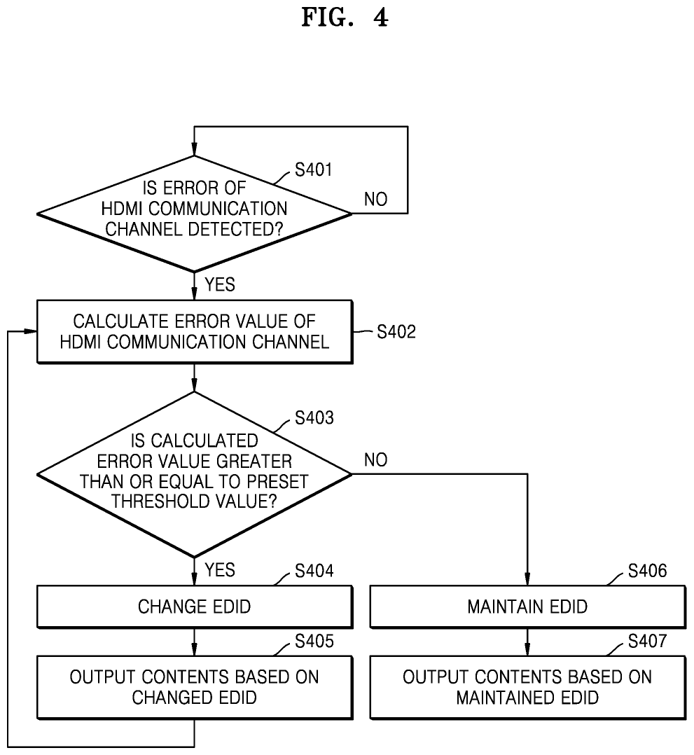

FIG. 4 is a flowchart for describing a method, performed by a display device, of changing or maintaining EDID based on an error value of an HDMI communication channel, according to an embodiment of the disclosure.

Referring to FIG. 4, in operation S401, the display device 100 may detect an error of an HDMI communication channel. Operation S401 may correspond to operation S302 in FIG. 3 described above.

According to an embodiment, the display device 100 may detect an error of an HDMI communication channel while receiving a video signal and an audio signal from the image providing apparatus 200 through an HDMI port.

The display device 100 may detect the error of the HDMI communication channel based on a preset time interval.

In operation S402, the display device 100 may calculate the error value of the HDMI communication channel. Operation S402 may correspond to operation S303 in FIG. 3.

Upon detection of the error of the HDMI communication channel, the display device 100 may calculate the error value of the HDMI communication channel, by using a predefined channel performance measurement algorithm. For example, the display device 100 may calculate the error value of the TMDS channel while changing the EQ value.

In operation S403, the display device 100 may determine whether the calculated error value is greater than or equal to a preset threshold value. Operation S403 may correspond to operation S303 in FIG. 3. Operations S404 through S407 may correspond to operations S303 and S304 in FIG. 3.

In operation S404, when the display device 100 determines that the error value of the TMDS channel is greater than or equal to the preset threshold value (S403: Yes), the display device 100 may change the EDID.

In operation S405, the display device 100 may output the contents based on the changed EDID.

According to an embodiment, the display device 100 may measure the performance of the HDMI communication channel while outputting the contents based on the changed EDID in operation S402. When the display device 100 determines that the error value of the TMDS channel is less than the preset threshold value (S403: No), the display device 100 may maintain the changed EDID.

That is, in operation S406, when the display device 100 determines that the error value of the TMDS channel is less than the preset threshold value, the display device 100 may maintain the EDID without changing the EDID. In operation S407, the display device 100 may output the contents based on the maintained EDID.

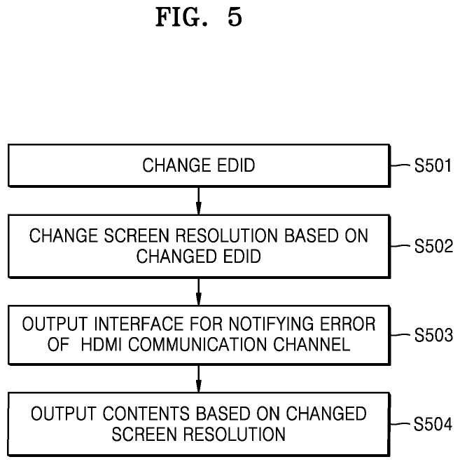

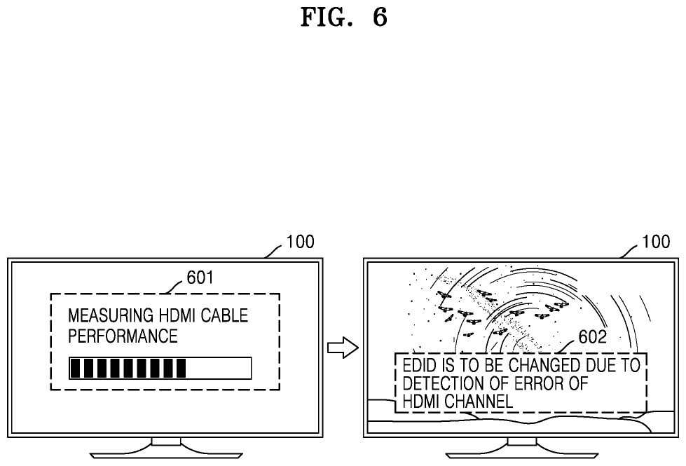

FIG. 5 is a flowchart for describing an example in which a display device changes EDID, according to an embodiment. FIG. 6 is a view for describing an example of an interface output by a display device, according to an embodiment. FIG. 6 is a view referred to for describing an embodiment of FIG. 5.

Referring to FIG. 5, in operation S501, the display device 100 may change the EDID.

According to an embodiment, as the display device 100 determines that the error value of the TMDS channel is greater than or equal to a preset threshold value during reception of a video signal and an audio signal from the image providing apparatus 200 through the TMDS channel, the display device 100 may change the EDID.

For example, the EDID may include a display support function, supported resolution information, timing information, etc.

In operation S502, the display device 100 may change a screen resolution based on the changed EDID.

According to an embodiment, the display device 100 may change a configuration of the screen resolution based on resolution information supported by the display, included in the changed EDID.

For example, the display device 100 may change the screen resolution into a low resolution, based on the changed EDID.

In operation S503, the display device 100 may output an interface for notifying the error of the HDMI communication channel.

Referring to FIG. 6, according to an embodiment, the display device 100 may display on a display, an interface 601 (e.g., “measuring HDMI cable performance”) to notify the user that the performance of the HDMI communication channel is being measured, in which an error may be detected.

As the display device 100 determines the error of the HDMI communication channel, the display device 100 may display on the display, an interface 602 (e.g., “EDID is to be changed due to detection of error in HDMI channel”) to notify the user about the error of the HDMI communication channel. However, the interface 602 is not limited thereto.

In operation S504, the display device 100 may output the contents based on the changed resolution.

According to an embodiment, the display device 100 may transmit display device information to the image providing apparatus 200. For example, the display device information may include EDID information.

According to an embodiment, when the EDID is changed, the display device 100 may transmit the changed EDID to the image providing apparatus 200 through the DDC channel. The image providing apparatus 200 may provide the contents based on the changed EDID.

According to an embodiment, the display device 100 may receive the contents provided based on the changed EDID and display the received contents on the display.

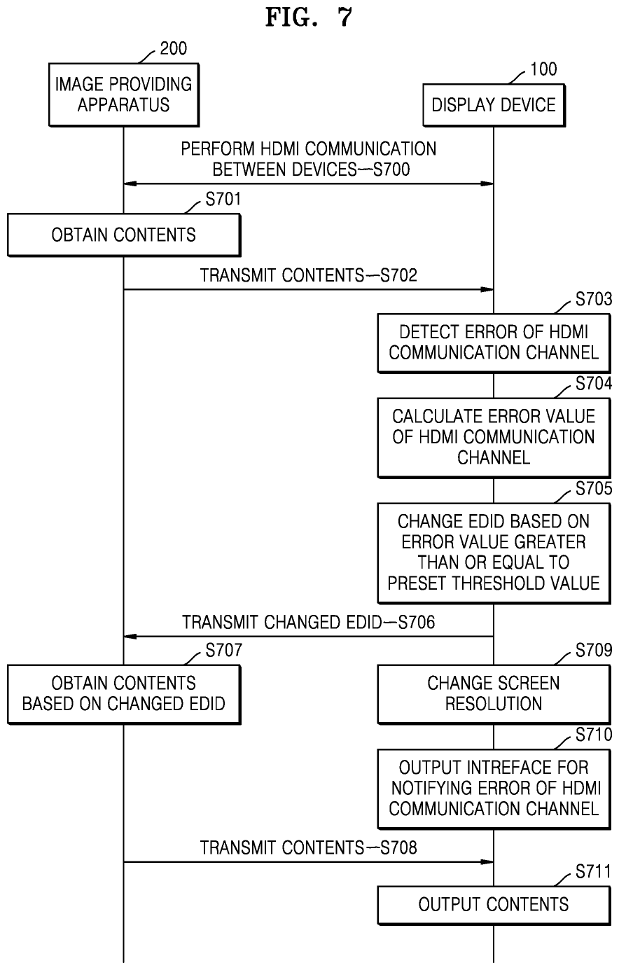

FIG. 7 is a flowchart of an operating method of a display device and an image providing apparatus, according to an embodiment.

Referring to FIG. 7, in operation S700, HDMI communication between the display device 100 and the image providing apparatus 200 may be performed.

For example, the display device 100 may perform HDMI communication upon establishing a connection with the image providing apparatus 200 through an HDMI port.

In operation S701, the image providing apparatus 200 may obtain contents. Here, the contents may be obtained from a broadcast station, a satellite, or any other outside source that provides contents.

For example, the image providing apparatus 200 may receive the contents from an external device. When a recording medium having recorded thereon image contents is inserted into the image providing apparatus 200, the image providing apparatus 200 may load the image contents recorded on the recording medium.

In operation S702, the image providing apparatus 200 may transmit the contents to the display device 100.

According to an embodiment, the display device 100 may detect an error of an HDMI communication channel while receiving a video signal and an audio signal from the image providing apparatus 200 through the TMDS channel.

In operation S703, the display device 100 may detect the error of the HDMI communication channel. Operation S703 may correspond to operation S302 in FIG. 3 and operation S401 in FIG. 4.

In operation S704, the display device 100 may calculate the error value of the HDMI communication channel. Operation S704 may correspond to operation S303 in FIG. 3 and operations S402 and S403 in FIG. 4.

In operation S705, the display device 100 may change the EDID based on determining that the error value is greater than or equal to a preset threshold value. Operation S705 may correspond to operation S304 in FIG. 3, operation S404 in FIG. 4, and operation S501 in FIG. 5.

In operation S706, the display device 100 may transmit the changed EDID to the image providing apparatus 200.

According to an embodiment, when the EDID is changed, the display device 100 may transmit the changed EDID to the image providing apparatus 200.

In operation S707, the image providing apparatus 200 may obtain the contents based on the changed EDID. For example, the changed EDID may indicate to obtain a higher quality image to be displayed by the display device 100. In operation S708, the image providing apparatus 200 may transmit the obtained contents based on the changed EDID to the display device 100.

According to an embodiment, as EDID including information about the display device 100 is changed, the image providing apparatus 200 may convert and transmit the contents such that the display device 100 outputs the contents in an optimal display environment based on the changed EDID.

In operation S709, the display device 100 may change the screen resolution. Operation S709 may correspond to operation S502 in FIG. 5.

In operation S710, the display device 100 may output an interface for notifying the error of the HDMI communication channel. Operation S710 may correspond to operation S503 in FIG. 5.

In operation S711, the display device 100 may output the contents based on the changed EDID.

According to an embodiment, the display device 100 may receive the contents converted based on the changed EDID from the image providing apparatus 200 and display the received contents on the display.

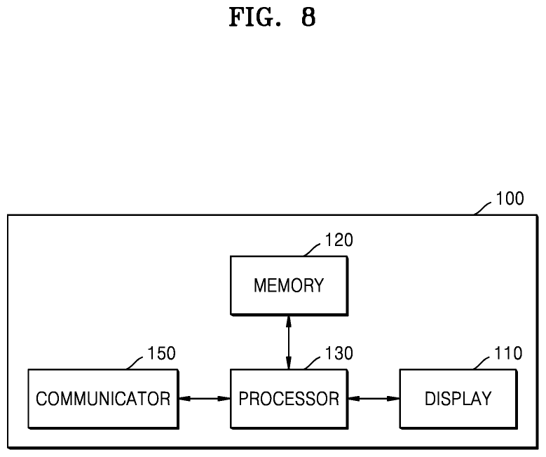

FIG. 8 is a block diagram of a display device according to an embodiment. FIG. 9 is a detailed block diagram of a display device according to an embodiment.

As shown in FIG. 8, the display device 100 according to an embodiment may include a memory 120, a processor 130, a communicator 150, and a display 110. However, one or more embodiments are not limited there to, and the display device 100 may be implemented with a larger or smaller number of elements than the illustrated elements.

For example, as shown in FIG. 9, the display device 100 according to an embodiment may further include a tuner unit 140, a detector 160, an input/output (I/O) unit 170, a video processor 180, an audio processor 115, an audio output unit 126, a power source unit 190, and a sensing unit 191, as well as the memory 120, the processor 130, the communicator 150, and the display 110.

Herein below, the foregoing elements will be described in more detail.

The processor 130 may control an overall operation of the display device 100 and control a signal flow among internal elements of the display device 100 to process data. The processor 130 may execute an operating system (OS) and various applications stored in the memory 120, when there is a user input or a preset and stored condition is satisfied.

The processor 130 may include a random access memory (RAM) that stores a signal or data input from the outside of the display device 100 or may be used as a storage region corresponding to various tasks performed in the display device 100. The processor 130 may include a ROM having stored therein a control program for controlling the display device 100.

The processor 130 may include a graphic processing unit (GPU) for processing graphics corresponding to video. The processor 130 may be implemented as a system on chip (SoC) in which a core processor and a GPU are integrated. The processor 130 may include a single core, a dual core, a triple core, a quad core, and a core of a multiple thereof.

The processor 130 may also include a plurality of processors. For example, the processor may be implemented with a main processor and a sub processor which operates in a sleep mode.

According to an embodiment, the processor 130 may perform HDMI communication connection with the image providing apparatus 200 through the communicator 150 by executing one or more instructions stored in the memory 120.

According to an embodiment, the processor 130 may detect the error of the HDMI communication channel by executing the one or more programs stored in the memory 120.

Upon detection of the error of the HDMI communication channel through execution of the one or more instructions stored in the memory 120, the processor 130 may calculate the error value of the HDMI communication channel, by using a predefined channel performance measurement algorithm.

The processor 130 may determine whether to change the EDID based on the calculated error value, by executing the one or more instructions stored in the memory 120.

The processor 130 may compare the calculated error value with a preset threshold value and change the EDID based on determining that the error value is greater than or equal to the preset threshold value, by executing the one or more instructions stored in the memory 120. The processor 130 may output the contents to the display 110 based on the changed EDID, by executing the one or more instructions stored in the memory 120.

The processor 130 may change the screen resolution based on the changed EDID, by executing the one or more instructions stored in the memory 120.

The processor 130 may output an interface for notifying the user about the error of the HDMI communication channel through the display 110, by executing the one or more instructions stored in the memory 120.

According to an embodiment, the processor 130 may compare the calculated error value with a preset threshold value and maintain preset EDID based on determining that the error value is less than the preset threshold value, by executing the one or more instructions stored in the memory 120. The processor 130 may output the contents to the display 110 based on the preset EDID, by executing the one or more instructions stored in the memory 120.

The memory 120 may store various data, programs, or applications for driving and controlling the display device 100 under control of the processor 130. The memory 120 may store input/output signals or data corresponding to driving of the video processor 180, the display 110, the audio processor 115, the audio output unit 126, the power supply unit 130, the tuner unit 140, the communicator 150, the detector 160, and the I/O unit 170.

The memory 120 may store an operating system 121 for control of the display device 100 and the processor 130, an application 122 that is initially provided from a manufacturer or downloaded from an external source, a graphic user interface (GUI) associated with an application, an object (e.g., an image, a text, an icon, a button, etc.) for providing the GUI, user information, a document, databases, or related data.

The memory 120 may include a TV viewer module 123 that includes one or more instructions for receiving an input signal from a remote control device, performing channel control corresponding to the input signal, or entering a channel scroll user interface mode when the input signal corresponds to a pre-designated input, a character recognition module 124 including one or more instructions for recognizing information from contents received from an external device, and an MBR module 125 including one or more instructions for channel control from an external device.

The memory 120 may include a read-only memory (ROM), a random access memory (RAM), or a memory card (e.g., a micro secure digital (SD) card, a USB memory, etc.) mounted on the display device 100. The memory 120 may include a non-volatile memory, a volatile memory, a hard disk drive (HDD), or a solid state drive (SSD).

According to an embodiment, the memory 120 may include a storage medium of at least one type of a flash memory type, a hard disk type, a multimedia card micro type, a card type memory (e.g., an SD or extreme digital (XD) memory, etc.), a RAM, a static random access memory (SRAM), a ROM, an electrically erasable programmable read-only memory (EEPROM), a programmable read-only memory (PROM), a magnetic memory, a magnetic disk, an optical disk, or the like.

According to an embodiment, the memory 120 may include an EDID ROM (see FIG. 2). According to an embodiment, the EDID ROM may store EDID information about the display device 100.

According to an embodiment, the memory 120 may store an HDMI channel performance measurement algorithm. The memory 120 may store an EQ value in a changeable range in the form of a table.

The display 110 may display video included in a broadcasting signal received through the tuner unit 140 on the screen under control of the processor 130. The display 110 may display the contents (e.g., video) input through the communicator 150 or the I/O unit 170. The display 110 may output an image stored in the memory 120 under control of the processor 130.

The display 110 may convert an image signal, a data signal, an on-screen display (OSD) signal, a control signal, or the like, processed by the processor 130, to generate a driving signal. The display 110 may be implemented with a plasma display panel (PDP), a liquid crystal display (LCD), an organic light-emitting diode (OLED), a cathode ray tube (CRT), a flexible display, etc., or a three-dimensional (3D) display. The display 110 may include a touch screen and thus may be used as an input device as well as an output device.

According to an embodiment, the display 110 may output the contents received from the image providing apparatus 200.

The display device 110 may also output an interface for notifying the user about the error of the HDMI communication channel.

The tuner unit 140 may be configured to select a frequency of a channel the display device 100 is to receive from among many electric wave components by tuning the frequency through amplification, mixing, resonance, or the like with respect to a broadcasting signal received in a wired or wireless manner. The broadcasting signal may include audio, video, and additional information (for example, an electronic program guide (EPG)).

The tuner unit 140 may receive a broadcasting signal in a frequency band corresponding to a channel number based on a user input (for example, a control signal received from a remote control device, such as a channel number input, a channel up-down input, and a channel input on an EPG screen).

The tuner unit 140 may receive a broadcasting signal from various sources such as terrestrial broadcasting, cable broadcasting, satellite broadcasting, Internet broadcasting, and so forth. The tuner unit 140 may receive a broadcasting signal from a source such as analog broadcasting, digital broadcasting, or the like. The broadcasting signal received through the tuner unit 140 may be decoded (e.g., audio-decoded, video-decoded, or additional-information-decoded) and separated into audio, video, and/or additional information. The separated audio, video, and/or additional information may be stored in the memory 120 under control of the processor 130.

There may be one or a plurality of tuner units 140 in the display device 100. The tuner unit 140 may be implemented as all-in-one with the display device 100 or as a separate device including a tuner unit electrically connected with the display device 100 (e.g., a set-top box or a tuner unit connected to the I/O unit 170).

The communicator 150 may connect the display device 100 with an external device (e.g., an audio device, etc.) under control of the processor 130. The processor 130 may transmit/receive contents to/from an external device connected through the communicator 150, download an application from the external device, or browse the web. The communicator 150 may include one of a wireless local area network (WLAN) 151, Bluetooth 152, and wired Ethernet 153, depending on capabilities and structure of the display device 100. The communicator 150 may include a combination of the WLAN 151, the Bluetooth 152, and the wired Ethernet 153.

The communicator 150 may receive a control signal of a remote control device under control of the processor 130. The control signal may be implemented as a Bluetooth type, an RF signal type, or a WiFi type.

The communicator 150 may further include other short-range communications (e.g., near field communication (NFC), Bluetooth Low Energy (BLE), etc.).

According to an embodiment, the communicator 150 may include an HDMI transceiver.

According to an embodiment, the display device 100 may transmit and receive an audio signal and/or a video signal, device information, a control command, etc., from and to the image providing apparatus 200 through HDMI communication.

The detector 160 may detect a user's voice, a user's image, or a user's interaction, and may include a microphone 161, a camera unit 162, and an optical receiver 163.

The microphone 161 may receive an audio signal including an uttered voice of the user. The microphone 161 may convert the received voice into an electric signal and output the electric signal to the processor 130. The user's voice may include, for example, a voice corresponding to a menu or a function of the display device 100.

The camera unit 162 may obtain an image bezel such as a still image, a moving image, etc. The image captured by the image sensor may be processed by the processor 130 or a separate image processor.

The image bezel processed by the camera unit 162 may be stored in the memory 120 or transmitted to the outside of the display device 100 through the communicator 150. Two or more camera units 162 may be provided according to a structural aspect of the display device 100.

The optical receiver 163 may receive an optical signal (including a control signal) received from an external remote control device. The optical receiver 163 may receive an optical signal corresponding to a user input (e.g., a touch, a press, a touch gesture, a voice, or a motion) from the remote control device. A control signal may be extracted from the received optical signal under control of the processor 130. For example, the optical receiver 163 may receive a control signal corresponding to a channel up/down button for changing a channel from the remote control device.

The I/O unit 170 may receive video (e.g., moving images, etc.), audio (e.g., a voice, music, etc.), and additional information (e.g., an EPG, etc.) from the outside of the display device 100, under control of the processor 130. The I/O unit 170 may include at least one of a high-definition multimedia interface (HDMI) port 171, a component jack 172, a PC port 173, or a universal serial bus (USB) port 174. The I/O unit 170 may include a combination of at least one of the HDMI port 171, the component jack 172, the PC port 173, or the USB port 174.

According to an embodiment, the image providing apparatus 200 may be connected to the display device 100 through the HDMI port 171.

The video processor 180 may perform processing on video data received by the display device 100. The video processor 180 may perform various image processing, such as decoding, scaling, noise filtering, bezel rate conversion, resolution conversion, etc., with respect to the video data.

A graphics processing unit (GPU) 181 may generate a screen including various objects such as an icon, an image, a text, etc., by using a calculator and a rendering unit. The calculator may calculate an attribute value such as coordinates, shapes, sizes, colors, etc., of respective objects based on a layout of the screen, by using a user input detected by the detector 160. The rendering unit may generate the screen of various layouts including an object based on the attribute value calculated by the calculator. The screen generated by the rendering unit may be displayed in a display region of the display 110.

The audio processor 115 may perform processing on audio data. The audio processor 115 may perform various processing such as decoding, amplification, noise filtering, etc., on the audio data. The audio processor 115 may include a plurality of audio processing modules to process audio corresponding to a plurality of contents.

The audio output unit 126 may output audio included in a broadcasting signal received through the tuner unit 140, under control of the processor 130. The audio output unit 126 may output audio (e.g., voice, sound, etc.) input through the communicator 150 or the I/O unit 170. The audio output unit 126 may output audio stored in the memory 120 under control of the processor 130. The audio output unit 126 may include at least one of a speaker 127, a headphone output terminal 128, or a Sony/Phillips digital interface (S/PDIF) output terminal 129. The audio output unit 126 may include a combination of at least one of the speaker 127, the headphone output terminal 128, or the S/PDIF output terminal 129.

The power source unit 190 may supply power, which is input from an external power source, to the internal elements of the display device 100, under control of the controller 130. The power source unit 190 may supply power, which is output from one or more batteries included in the display device 100, to the internal elements, under control of the processor 130.

The sensing unit 191 may sense a state of the display device 100 or a state near the display device 100, and may transmit sensed information to the processor 130.

The sensing unit 191 may include, but not limited to, at least one of a magnetic sensor 192, an acceleration sensor 193, a temperature/humidity sensor 194, an infrared sensor 195, a gyroscope sensor 196, a positioning sensor (e.g., a global positioning system (GPS)) 197, a barometric pressure sensor 198, a proximity sensor 199, or a red/green/blue (RGB) sensor (or an illuminance sensor) 201.

The sensing unit 191 according to an embodiment may detect an external shock applied to the display device 100. For example, when the display device 100 is implemented with a touch panel, the sensing unit 191 of the display device 100 may sense the touch on the touch panel and output a sensing value according to the sensed touch on the touch panel.

The display device 100 including the display 110 may be electrically connected to a separate external device (e.g., a set-top box) including the tuner unit 140.

It may be understood by those of ordinary skill in the art that the display device 100 may be implemented with, but not limited to, an analog TV, a digital TV, a 3D TV, a smart TV, an LED TV, an OLED TV, a plasma TV, a monitor, or the like.

In addition, the block diagram of the display device 100 only illustrates an example embodiment of the disclosure. Elements of the block diagram may be integrated, added, or omitted depending on the specifications of the display device 100. That is, when it is necessary, two or more elements may be integrated into one element or one element may be divided into two or more elements. A function executed in each element (or module) is to describe embodiments of the disclosure, and a detailed operation or apparatus thereof does not limit the scope of the disclosure.

The foregoing one or more embodiments of the disclosure may be written as a program executable on computers, and may be implemented on a computer operating the program by using a computer-readable medium. In addition, a structure of data used in the foregoing embodiment may be recorded on a non-transitory or non-volatile computer-readable medium using various means. Moreover, the foregoing embodiments may be implemented in the form of a recording medium including a computer-executable instruction such as a programming module executed by a computer. For example, methods implemented with a software module or algorithm may be stored in a computer-readable recording medium as codes or program commands that are readable and executable by computers.

The computer-readable medium may be an arbitrary recording medium that is accessible by a computer, and may include all of a volatile medium, a non-volatile medium, a separated medium, and a non-separated medium. The computer-readable medium may include, but not limited to, a storage medium, for example, a magnetic storage medium such as a read-only memory (ROM), a floppy disk, a hard disk, etc., an optical reading medium such as a compact-disc (CD)-ROM, a digital versatile disc (DVD), etc. The computer-readable medium may also include both a computer storage medium and a communication medium.

Moreover, a plurality of computer-readable recording media may be distributed over network-connected computer systems, and data, for example, program instructions and codes, stored in the distributed recording media, may be executed by at least one computer.

The particular implementations described in the disclosure are illustrative examples and are not intended to limit the scope of the disclosure. For the sake of brevity, conventional electronics, control systems, software development and other functional aspects of the systems may not be described in detail.

Those of ordinary skill in the art to which the disclosure pertains may understand that the one or more embodiments of the disclosure may be implemented in different ways without departing from the technical spirit or essential characteristics of the disclosure. Thus, it should be noted that the above-described embodiments of the disclosure are provided as examples and should not be interpreted as limiting the scope of the disclosure. For example, each element described as a single type may be implemented in a distributed manner, and likewise, elements described as being distributed may be combined and then executed.

The use of all examples or exemplary terms, (e.g., “etc.”) is merely used to describe additional elements included in the one or more embodiments of the disclosure while not specifically named, and the scope is not necessarily limited by the examples or exemplary terms unless defined by the claims.

Moreover, no item or component is essential to execution of the disclosure unless the element is specifically described as “essential” or “critical”.

It would be understood by those of ordinary skill in the art that the disclosure may be implemented in a modified form without departing from the essential characteristics of the disclosure.

The disclosure may have various modifications, substitutions, and improvements thereof, and the disclosure is not limited by the specific embodiments described in the one or more embodiments hereinabove, and it should be understood that all modifications, equivalents, or substitutions fall within the spirit and scope of the disclosure. Therefore, the embodiments of the disclosure should be understood in an illustrative sense rather than a restrictive sense.

The scope of the disclosure is further defined by the following claims, and the meanings and scope of the claims and all changes or modified forms derived from their equivalents should be construed as falling within the scope of the disclosure.

The term used in the embodiments of the disclosure such as “unit” or “module” indicates a unit for processing at least one function or operation, and may be implemented in hardware, software, or in a combination of hardware and software.

The term “unit” or “module” may be implemented by a program that is stored in an addressable storage medium and executable by a processor.

For example, the term “unit” or “module” may include software components, object-oriented software components, class components and task components, processes, functions, attributes, procedures, subroutines, segments of a program code, drivers, firmware, microcode, circuitry, data, databases, data structures, tables, arrays, and variables.

Herein, the mentioning “A may include one of a1, a2, and a3” may have a large meaning that an exemplary element included in an element A is a1, a2, or a3.

Further, an element constituting the element A may not be necessarily limited to a1, a2, or a3. Thus, it should be noted that the element constituting the element A may not be exclusively interpreted as meaning that other elements that are not listed, except for a1, a2, and a3, are excluded.

In addition, A includes a1, includes a2, or includes a3. The elements constituting A are selectively determined as deemed necessary in a certain set. For example, it should be noted that the element A should not be interpreted as a1, a2, or a3, selected from a set including a1, a2, and a3, necessarily constituting the component A.

What is claimed is:

1. An operating method of a display device configured to receive contents through a high-definition multimedia interface (HDMI) communication from an image providing apparatus, the operating method comprising:
performing the HDMI communication with the image providing apparatus;
detecting an error of an HDMI communication channel;
calculating an error value of the HDMI communication channel by using a predefined channel performance measurement algorithm based on the error of the HDMI communication channel being detected;
determining whether to change extended display identification data (EDID) based on the calculated error value; and
outputting the contents based on the EDID corresponding to a result of the determining.

2. The operating method of claim 1, wherein the determining of whether to change the EDID comprises:
comparing the calculated error value with a preset threshold value; and
changing the EDID based on determining that the error value is greater than or equal to the preset threshold value, and
wherein the outputting of the contents comprises outputting the contents based on the changed EDID.

3. The operating method of claim 2, wherein the changing of the EDID comprises changing a screen resolution based on the changed EDID.

4. The operating method of claim 2, wherein the changing of the EDID comprises outputting an interface for notifying a user about the error of the HDMI communication channel.

5. The operating method of claim 1, wherein the determining of whether to change the EDID comprises:
comparing the calculated error value with a preset threshold value; and
maintaining the EDID based on the error value being less than the preset threshold value, and
wherein the outputting of the contents comprises outputting the contents based on the EDID.

6. The operating method of claim 1, wherein the predefined channel performance measurement algorithm comprises an algorithm that calculates the error value while changing an EQ value.

7. A display device configured to receive contents through a high-definition multimedia interface (HDMI) communication from an image providing apparatus, the display device comprising:
a communicator;
a memory storing one or more instructions; and
a processor configured to execute the one or more instructions stored in the memory to:
perform the HDMI communication with the image providing apparatus through the communicator;
detect an error of an HDMI communication channel;
calculate an error value of the HDMI communication channel by using a predefined channel performance measurement algorithm based on the error of the HDMI communication channel being detected;
determine whether to change extended display identification data (EDI D) based on the calculated error value; and
output the contents based on the EDID corresponding to a result of the determining.

8. The display device of claim 7, wherein the processor is further configured to:
compare the calculated error value with a preset threshold value;
change the EDID when the error value is greater than or equal to the preset threshold value; and
output the contents based on the changed EDID.

9. The display device of claim 8, wherein the processor is further configured to change a screen resolution based on the changed EDI D.

10. The display device of claim 8, wherein the processor is further configured to output an interface for notifying a user about the error of the HDMI communication channel.

11. The display device of claim 7, wherein the processor is further configured to:
compare the calculated error value with a preset threshold value;
maintain the EDID based on the error value being less than the preset threshold value; and
output the contents based on the EDID.

12. The display device of claim 7, wherein the predefined channel performance measurement algorithm comprises an algorithm that calculates the error value while changing an EQ value.

13. A non-transitory computer-readable recording medium having recorded thereon a program for executing the method of claim 1 on a computer.
